(19) United States
(12) Patent Application Publication
(10) Pub. No.: US 2015/0219281 A1
(43) Pub. Date: Aug. 6, 2015

(54) VALVE ASSEMBLY

(71) Applicant: S.P.A. AUTOMOTIVE LIMITED, Lichfield (GB)

(72) Inventors: Richard BARNES, Lichfield (GB); Steven HAWKINS, Lichfield (GB); Tony TAYLOR, Lichfield (GB); Edward CHERRY, Lichfield (GB)

(21) Appl. No.: 14/615,586

(22) Filed: Feb. 6, 2015

(30) Foreign Application Priority Data
Feb. 6, 2014 (GB) 1402019.2

(51) Int. Cl. F17C 13/00; A62C 37/00

(52) U.S. Cl. CPC F17C 13/002; A62C 37/00

(57) ABSTRACT

A valve assembly for controlling the release or delivery of a fluid or other medium from a vessel. The valve assembly comprises an inlet, an outlet, valve means operable to selectively open or close fluid communication between the inlet and the outlet and lock means for engaging the valve means, wherein the lock means is configured to engage, in use, the valve means when it opens, thereby to lock the valve means in an open condition.

### FIELD OF THE INVENTION

This invention relates generally to a valve assembly and more particularly to a valve assembly for enabling controlled release or delivery of a fluid or other medium. More specifically, although not exclusively, this invention relates to a valve assembly for incorporation into the delivery device of a pressurised vessel. More specifically, although not exclusively, this invention is concerned with manually operated valves and more specifically to manually operated valves for emergency equipment, such as fire extinguishers and the like.

### BACKGROUND OF THE INVENTION

Valve assemblies for controlling the release or delivery of a fluid or other medium contained within pressurised vessels, e.g., fire extinguishers, are generally controlled manually or automatically and/or electronically.

Conventional fire extinguishers are designed to enable the user to actively control the amount of extinguishing fluid or medium expelled from the delivery nozzle. Such devices normally include a safety pin that is pulled or removed to enable manual actuation of a scissor-like handle, which selectively releases the extinguishing medium on actuation. This arrangement requires the user to determine the appropriate quantity of extinguishing medium to be used based on the circumstances.

Whilst such an arrangement is appropriate for most applications, there are certain high risk environments in which underestimation of the quantity of fluid or other medium needed can result in serious injury or death. One such application is in the field of racing, where the reaction time of emergency response is crucial.

### OBJECTS OF THE INVENTION

It is therefore a first non-exclusive object of the invention to provide a valve assembly for a pressure vessel that overcomes or at least mitigates the issues associated with prior art valve assemblies.

It is a further, more general non-exclusive object of the invention to provide an improved valve assembly.

### SUMMARY OF THE INVENTION

Accordingly, a first aspect of the invention provides a valve assembly, e.g. for controlling the release or delivery of a fluid or other medium from a vessel, the valve assembly comprising an inlet, an outlet, valve means operable to selectively open or close fluid communication between the inlet and the outlet and lock means for engaging the valve means, wherein the lock means is configured to engage, in use, the valve means when it opens, for example when it moves or changes from a closed position or condition to an open position or condition, e.g. to lock the valve means in an open position or condition.

Preferably, the lock means is configured to engage the valve means automatically when it opens. The lock means may also be configured to engage, in use and/or automatically, the valve means when it closes, for example when it moves or changes from the open position or condition to the closed position or condition, e.g. to lock the valve means in a closed position or condition.

The valve means may be biased, in use, toward one of the open and closed positions or conditions. Additionally or alternatively, the valve assembly may further comprise a release means. Operation, in use, of the release means may cause or allow or permit the valve means to move or change to the position or condition toward which it is biased.

A second aspect of the invention provides a valve assembly, e.g. for controlling the release or delivery of a fluid or other medium from a vessel, the valve assembly comprising an inlet, an outlet, release means and valve means operable to selectively open or close fluid communication between the inlet and the outlet, wherein the valve means is biased, in use, toward an open or a closed position or condition such that operation of the release means causes or allows or permits the valve means to move or change to the position or condition toward which it is biased.

The valve assembly or release means may comprise an abutment means, which may be movable or changeable between a deployed position or condition, for example in which the valve means may be biased thereagainst, e.g. and inhibited from opening or closing, and an undeployed or retracted position or condition, e.g. in which the valve means may be able to open or close. Additionally or alternatively, the valve assembly or release means may comprise an activation or actuation means, e.g. for operating the valve means or for causing it to open or close fluid communication between the inlet and the outlet and/or for operating the abutment means or for causing it to move or change between the deployed and undeployed or retracted positions or conditions.

A third aspect of the invention provides a valve assembly, e.g. for controlling the release or delivery of a fluid or other medium from a vessel, the valve assembly comprising an inlet, an outlet, an actuator, an abutment means and a valve means operable to selectively open or close fluid communication between the inlet and the outlet, wherein the actuator is operable to move or change, in use, the abutment means from a deployed position or condition in which the valve means is biased thereagainst and inhibited from opening or closing to an undeployed or retracted position or condition in which the valve means is able to open or to close.

For the avoidance of doubt, any of the features described herein apply equally to any aspect of the invention.

The lock means may comprise a lock and/or the valve means may comprise a valve element or member and/or the abutment means may comprise an abutment and/or the activation or actuation means may comprise an activator or actuator. The valve means may be movable or changeable between open and closed positions or conditions. The lock means may be movable or changeable between a deployed position or condition, for example in which the lock means inhibits movement or changing of the valve means, and an undeployed or retracted position or condition, e.g. in which the lock means does not inhibit the movement or changing of the valve means. The valve assembly may comprise a body, for example which includes or incorporates or defines the inlet and/or the outlet.

In some preferred embodiments, the valve means is biased, in use, toward the open position or condition, for example such that the valve means moves to the open position or condition, e.g. from the closed position or condition, when the abutment means moves or changes from the deployed position or condition to the undeployed or retracted position or condition.

In some embodiments, activation or actuation, in use, of the activation or actuation means causes the or a lock means to move or change from the undeployed or retracted position or condition to the deployed position or condition.

Preferably, the lock means is associated with the abutment means, wherein movement of the abutment means between deployed and undeployed or retracted positions or conditions causes the lock means to move between deployed and undeployed or retracted positions or conditions. In a particularly preferred embodiment, movement of the abutment from the deployed position or condition to the undeployed or retracted position or condition causes the lock means to move from the undeployed or retracted position or condition to the deployed or retracted position or condition, although the opposite arrangement may be beneficial in certain circumstances.

The valve assembly or activation or actuation means may comprise an activation or actuation element or member or piston, which may comprise the abutment means and/or the lock means. The activation or actuation means may be movable between a first position or condition, for example in which the abutment means is deployed or in the deployed position or condition and/or the lock means is disengaged from the valve means, such as in the undeployed or retracted position or condition, and a second position or condition, e.g. in which the abutment means is undeployed or retracted or in the undeployed or retracted position or condition and/or the lock means engages the valve means or is in the deployed position or condition.

In some embodiments, the abutment means is at least partially provided by the activation or actuation element or member or piston, for example a portion or surface, e.g. an external surface, thereof and/or the lock means is at least partially provided by the activation or actuation element or member or piston, for example a further portion or surface thereof, e.g. a depression or recess or aperture or hole therein. In a particularly preferred embodiment, the valve means comprises a valve element or member biased, in use, against the outer surface, e.g. when the activation piston is in the deployed condition, and/or partly received in the recess, e.g. when the activation piston is in the retracted condition.

Preferably, the release means further comprises a release element or member, which may comprise or incorporate or be associated with the abutment means and/or lock means, for example configured to selectively prevent movement or changing of the abutment means and/or lock means and/or activation or actuation element or member or piston. The release element or member may be operated or activated by one or more of moving, such as by translation or rotation or removal, separating or severing or splitting or breaking or modifying its shape. In one preferred embodiment, the release means or element or member comprises a pin, such as a deactivation or safety or release pin, which may be received, e.g. releasably received, in or by the valve assembly, for example in or by one or more of the activation element, the body, the abutment means and/or the lock means.

In some embodiments, the assembly comprises an activation piston and a release pin, wherein removal or severing of the release pin releases the piston to move from the first position or condition to the second position or condition.

The valve means may be biased by a biaser or biasing means, which may comprise a pressurised fluid or medium, e.g. within a pressurised vessel to which the valve assembly is mounted, in use, or with which the valve assembly is associated, and/or a resilient biaser or biasing means such as a spring or resilient element or member.

The activation or actuation means may be biased toward the first position or condition, for example such that the bias must be overcome to move or change the activation or actuation means from the first position or condition to the second position or condition. In such embodiments, the valve assembly or activation or actuation means may comprise one or more, e.g. two, pull elements or members or rods or cables.

In an alternative embodiment, the activation or actuation means may be biased toward the second position or condition, for example such that the bias must be overcome to move or change the activation or actuation means from the second position or condition to the first position or condition. In such embodiments, the release means may selectively prevent the activation or actuation means from moving or changing from the first to the second position or condition. Activation of the release means may release the activation or actuation means, e.g. thereby allowing it to move or change from the first to the second position or condition.

Preferably, the first position or condition of the valve member comprises the closed position or condition and/or the second position or condition of the valve member comprises the open position or condition. Alternatively, the first position or condition of the valve member may comprise the open position or condition and/or the second position or condition of the valve member may comprises the closed position or condition.

Further aspects of the invention provide a vessel containing a pressurised fluid or medium, which may comprise an extinguishing fluid or medium, and a fire extinguisher or fire extinguishing device, each of which may comprise the valve assembly described above.

Yet further aspects of the invention provide a kit of parts for assembly into a valve assembly and/or a vessel and/or a fire extinguisher as described above and a method of assembling and/or operating a valve assembly as described above.

### BRIEF DESCRIPTION OF THE DRAWINGS

Embodiments of the invention will now be described by way of example only with reference to the accompanying drawings in which:

FIG. 1 is a perspective view of a valve assembly according to one embodiment of the invention with the elements of the activation means shown in an exploded view;

FIG. 2 is an exploded perspective view of the valve elements of the valve assembly of FIG. 1;

FIG. 3 is an exploded top view of the peripheral elements of the valve assembly of FIG. 1;

FIG. 4 is a partial section view of the valve assembly of FIG. 1 in an assembled condition with the valve member in a closed position; and

FIG. 5 is a partial section view similar to that of FIG. 4, but showing the valve member in an open position.

### DESCRIPTION OF THE INVENTION

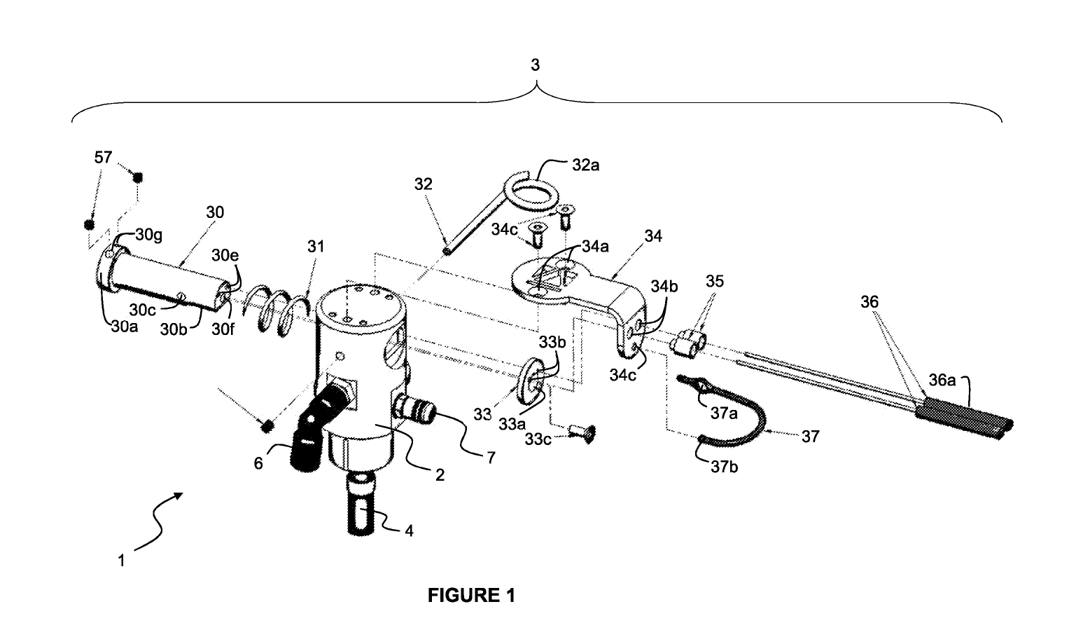

Referring to FIGS. 1 to 3, there is shown a valve assembly 1 for controlling the release or delivery of a fluid or other medium from a vessel (not shown). In this embodiment, the valve assembly 1 is designed for mounting to, or incorporation in, a fire extinguisher (not shown). The valve assembly 1 includes a body 2, an activation assembly 3, a dip tube 4, a valve piston 5, an outlet fitting 6, a refill inlet valve assembly 7, a pressure relief assembly 8 and a pressure gauge 9.

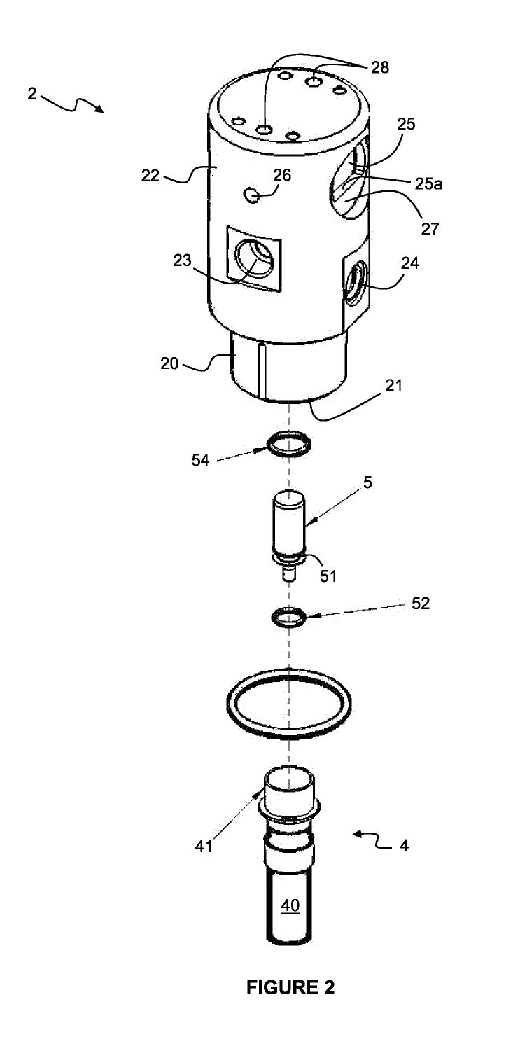

The body 2, shown more clearly in FIG. 2, includes a cylindrical lower portion 20 with a dip tube inlet 21 on a lower surface of the lower portion 20 corresponding to the opening of a blind axial bore 21a extending into a cylindrical upper portion 22. The upper body portion 22 has a larger diameter than the lower portion 20 and includes an outlet 23, a refill inlet 24, an activation piston bore 25, a deactivation pin hole 26, a stop recess 27, a pair of blind threaded mounting holes 28 on a top surface thereof, a pressure relief port 29 and a pressure gauge port (not shown).

The refill inlet bore 24 extends radially into the upper portion 22, intersects the dip tube inlet bore 21a and is adapted to receive and sealing engage the refill inlet valve assembly 7 by an O-ring seal 70. The pressure relief port 29 and pressure gauge port (not shown) also extend radially into the upper portion and communicate with the dip tube inlet bore 21a at approximately the same point as, but at 90° with respect to, the refill inlet bore 14. The outlet bore 23 extends radially through the upper portion 22 axially above or downstream of the refill inlet bore 24 and at 90° with respect thereto and is adapted to receive and engage with the outlet fitting 6. The activation piston bore 25 extends radially through the upper portion 22 from one side to the other axially above or downstream of the outlet 23 and intersects the dip tube inlet bore 21a. One end of the activation piston bore 25 includes a radial step 25a that forms the base of the stop recess 26, while the other end thereof is open. The deactivation pin hole 26 extends radially through the upper portion 22 from one side to the other in axial alignment and intersecting with the activation piston bore 25.

The activation assembly 3 includes an activation piston 30, a spring 31, a pin 32, a stop washer 33, a bracket 34, a pair of pull cable ferrules 35, a pair of pull cables 36 and a pin lanyard 37. The activation piston 30, is cylindrical with a flange or head 30a at one end, a keyed portion or undercut 30b extending from its other end on an intended lower side of the piston 30, a radial through hole 30c adjacent the inner end of the keyed portion 30b and a radial locking recess 30d adjacent the centre of the piston 30 and also on the intended lower side thereof. The piston 30 also includes a pair of axial through holes 30e, a threaded fixing hole 30f and a pair of threaded pull cable retaining screw holes 30g extending from a circumferential surface of the head 30a and intersecting the axial through holes 30e.

The spring 31 is in the form of a helical compression spring in this embodiment and is configured to receive the piston 30 with one end of the spring 31 engaging the head 30a in use. The pin 32 is formed of a rod bent at one end to form a ring 32a. The stop washer 33 is in the form of a disc with a central, tapered fixing hole 33a and a pair of through holes 33b. The bracket 34 is L-shaped with first, longer limb having a pair of tapered fixing holes 34a and a second, shorter limb having a pair of through holes 34b for receiving the pull cables 36 and a lanyard hole 34c. Each ferrule 35 is tubular and securely receives one of the pull cables 36 in abutment with a handle 36a thereof. The pin lanyard 37 is substantially in the form of a J in this embodiment with a loop or hole 37a adjacent the end of the long limb and an oversized head 37b at the other end thereof.

Referring now to FIG. 2, the dip tube 4 includes a tube 40 with a fitting 41 at its upper end for cooperation with the dip tube inlet 21. The valve piston 5 is substantially cylindrical in shape with a tapered end 50 and a circumferential groove 51 adjacent the tapered end 50 that receives an O-ring seal 52.

In an assembled condition, the activation piston 30 and spring 31 are both received within the open end of the activation piston bore 25 such that the spring 31 is captivated between the piston head 30a and the radial step 25a. The stop washer 33 is received within the stop recess 27 of the body 2 and is secured to the activation piston 30 by a fixing screw 33c that extends through the fixing hole 33a and threadedly engages the fixing hole 30f of the activation piston 30, thereby retaining the piston 30 within the activation piston bore 25.

The pin 32 is received within the deactivation pin hole 26 of the body 2 and extends through the radial through hole 30c of the activation piston 30, thereby preventing movement of the activation piston 30 within the activation piston bore 25 of the body 2. The hole 37a of the pin lanyard 37 receives the ring 32a of the pin 32, while the other end of the lanyard 37 is inserted into the lanyard hole 35 such that the lanyard head 37b inhibits its removal therefrom.

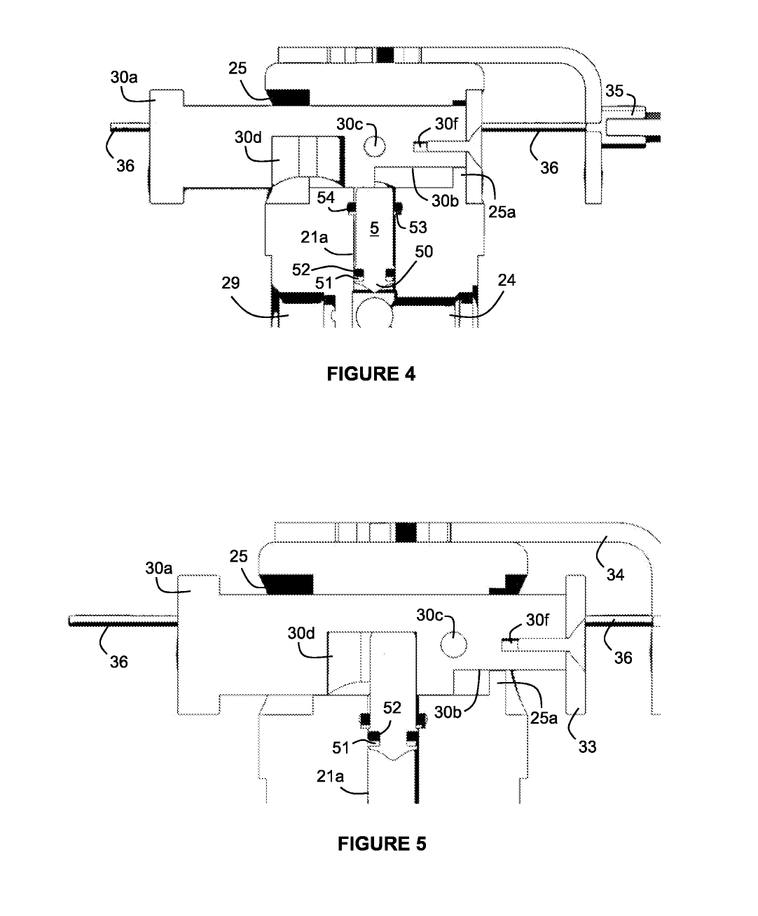

The valve piston 5 is sealingly received within the dip tube bore 24, which includes a circumferential groove 53 that receives a second O-ring seal 54. As shown in FIG. 4, the valve piston 5 is positioned in an upper portion of the dip tube bore 24 such that the outlet 23 (not shown in FIG. 4) is located between the two seals 52, 54, thereby isolating the dip tube 4 from the outlet 23. The valve piston 5 is also in abutment with an outer, circumferential surface of the activation piston 30 and is biased thereagainst by the pressurised fluid or medium within a vessel (not shown) to which the valve assembly 1 is connected.

The bracket 34 is mounted to the body 2 by a pair of fasteners 34c that extend through the fixing holes 34a and threadedly engage corresponding holes 28 in the top of the body 2. Each of the pull cables 36 extends through one of the through holes 34b in the bracket 34, through one of the through holes 33b in the stop washer 33 and is received within one of the axial through holes 30d of the piston 3 and is secured therein by a retaining screw 36a that engage with one of the threaded retaining screw hole 30f in the piston 3.

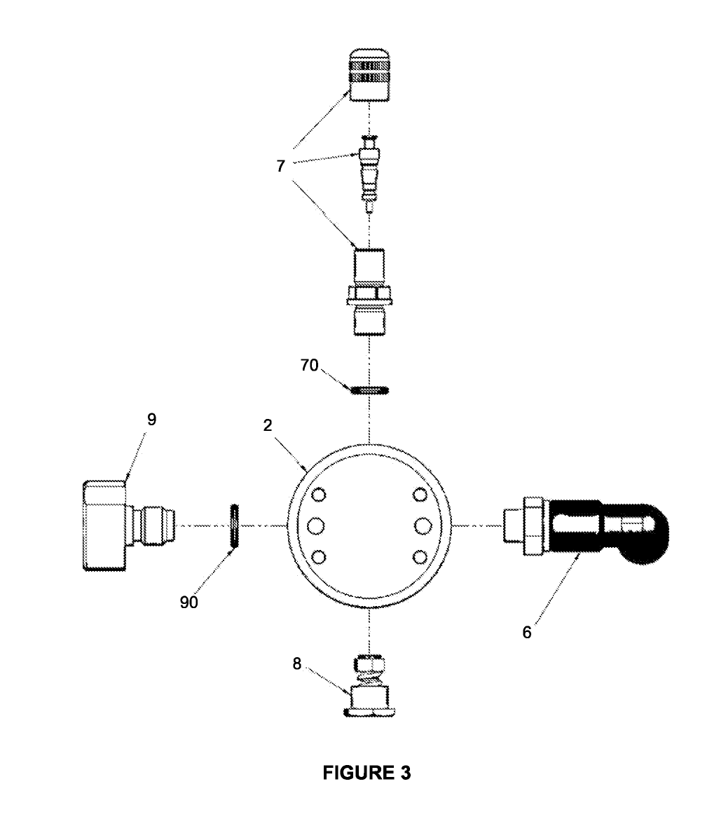

As shown in FIG. 3, the outlet fitting 6 includes a threaded portion that threadedly engages the outlet 23 of the body 2 and an L-shaped tubular portion. The refill inlet valve assembly 7 is of a spring loaded poppet valve design known in the art and is secured in threaded engagement with one end of the refill inlet bore 24 by an O-ring seal 70, while the pressure relief assembly 8 is threadedly received within the other end of the refill inlet bore 24. The pressure gauge 9 is of a standard design and is received within the pressure gauge port (not shown) of the body 2 and sealingly engaged therewith by an O-ring seal 90.

In use, the pin 32 is removed from the body 2 and the pull cables 36 are pulled to move the activation piston 30 from the position shown in FIG. 4 to the position shown in FIG. 5. The pull cables 36 are pulled against the biasing force of the spring 31 until the valve piston 5 aligns with the locking recess 30d of the activation piston 30, at which point the biasing force of the pressurised fluid or medium within the vessel (not shown) urges the valve piston 5 into the recess 30d. Movement of the piston 5 into the recess 30d opens fluid communication between the dip tube 4 and the outlet 23, thereby releasing the fluid or medium from the vessel (not shown) and out through the outlet fitting 6, which is connected to a delivery means (not shown), such as a nozzle in use.

When the pull cables 36 are released, the activation piston 30 is urged back toward its original position by the biasing spring 31. However and as shown in FIG. 5, the valve piston 5 is partially located in the locking recess 30d of the activation piston 30 and in the dip tube bore 21a, thereby preventing the activation piston 30 from returning to its original position. The force of the spring 31 also locks the valve piston 5 in the open position, thereby ensuring that the contents of the vessel (not shown) are depleted.

It will be appreciated by those skilled in the art that several variations to the aforementioned embodiments are envisaged without departing from the scope of the invention. For example, the activation assembly 3 may function in reverse, wherein the spring 31 urges the activation piston 31 toward the position shown in FIG. 5 but such movement is prevented by the presence of the release pin 32 such that, on removal of the release pin 32, the activation assembly 3 automatically moves to the position shown in FIG. 5, thereby opening the valve assembly 1. The skilled person would readily appreciate other variations in keeping with the scope of the disclosure herein.

It will also be appreciated by those skilled in the art that any number of combinations of the aforementioned features and/or those shown in the appended drawings provide clear advantages over the prior art and are therefore within the scope of the invention described herein.

1. A valve assembly for controlling the release or delivery of a fluid or other medium from a vessel, the valve assembly comprising an inlet, an outlet, valve means operable to selectively open or close fluid communication between the inlet and the outlet and a lock for engaging the valve means, wherein the lock is configured to engage, in use, the valve means when it opens, thereby to lock the valve means in an open condition.

2. The valve assembly according to claim 1, wherein the lock is configured to engage the valve means automatically when the valve means moves from a closed condition to an open condition.

3. The valve assembly according to claim 1, wherein the valve means is biased, in use, toward the open condition.

4. The valve assembly according to claim 3, wherein the valve means is configured to be biased by a pressurised fluid or other medium contained in a vessel to which the valve assembly is connected or associated in use.

5. The valve assembly according to claim 3 further comprising a release mechanism, wherein operation, in use, of the release mechanism causes or permits the valve means to move to the open condition.

6. The valve assembly according to claim 5, wherein the release mechanism comprises an abutment movable from a deployed condition in which the valve means is biased thereagainst and inhibited from opening to a retracted condition in which the valve means is able to open.

7. The valve assembly according to claim 6 further comprising an activator which includes at least part of the lock and at least part of the abutment, wherein operation, in use, of the activator causes the abutment to retract and the lock to engage the valve means.

8. The valve assembly according to claim 7, wherein the activator is biased toward a first condition in which the abutment is deployed and the lock is disengaged from the valve means.

9. The valve assembly according to claim 7, wherein the activator comprises an activation piston having an outer surface providing at least part of the abutment and a recess providing at least part of the lock.

10. The valve assembly according to claim 9, wherein the valve means comprises a valve element or member biased, in use, against the outer surface when the activation piston is in the deployed condition and is partly received in the recess when the activation piston is in the retracted condition.

11. The valve assembly according to claim 6 further comprising an actuator operable to move the abutment from the deployed condition to the retracted condition.

12. The valve assembly according to claim 6 further comprising a release element configured to selectively prevent movement of the abutment and/or lock and/or activator.

13. The valve assembly according to claim 1, wherein the valve means comprises one or more valves.

14. The valve assembly according to claim 1 in combination with a vessel containing a pressurised fluid or medium, the valve assembly being in fluid communication with the vessel.

15. Combination according to claim 14, wherein the fluid or medium comprises a fire extinguishing fluid or medium, wherein the combination comprises a fire extinguisher.

16. A valve assembly for controlling the release or delivery of a fluid or other medium from a vessel, the valve assembly comprising an inlet, an outlet, a release element or mechanism and valve means operable to selectively open or close fluid communication between the inlet and the outlet, wherein said valve means is biased, in use, toward an open condition or a closed condition such that operation of the release element or mechanism causes or permits the valve means to move or change to the condition toward which it is biased.

17. The valve assembly according to claim 16, wherein the valve means is biased toward the open position.

18. The valve assembly according to claim 16, wherein the valve means is biased toward the closed position.

19. A valve assembly for controlling the release or delivery of a fluid or other medium from a vessel, the valve assembly comprising an inlet, an outlet, an actuator, an abutment and one or more valves operable to selectively open or close fluid communication between the inlet and the outlet, wherein the actuator is operable to move or change, in use, the abutment from a deployed position or condition in which at least one of the valves is biased thereagainst and inhibited from opening or closing to an undeployed or retracted position or condition in which the at least one valve is able to open or to close.

20. The valve assembly according to claim 19, wherein the one or more valves are biased toward the open position.
